(19) United States
(12) Patent Application Publication
(10) Pub. No.: US 2003/0078777 A1
(43) Pub. Date: Apr. 24, 2003

(54) Speech recognition system for mobile Internet/Intranet communication

(76) Inventor: Shyue-Chin Shiau, Cupertino, CA (US)

Correspondence Address: BAKER & McKENZIE, 12th Floor, 101 West Broadway, San Diego, CA, 92101, US

(21) Appl. No.: 09/935,273

(22) Filed: Aug. 22, 2001

(51) Int. Cl. G10L 15/04

(52) U.S. Cl. 704/251

(57) ABSTRACT

An accurate speech recognition system operable for hand-held devices having relatively low computational power and memory requirements, low power consumption, simple operating systems, low weight and low cost. This invention provides accurate speech recognition for electronic devices with low processing power and limited memory storage capability. Basic accuracy is achieved by the utilization of specialized and/or individualized dictionary databases comprising several thousand words appropriate for specific uses such as website locating and professional/commercial lexicons. Further accuracy is achieved by first recognizing individual words and then matching aggregations of those words with word string databases. Still further accuracy is achieved by the use of processors and databases that are located at the telecommunications sites. Almost total accuracy is achieved by a scrolling selection system of candidate words. The invention comprises a microphone and a front-end signal processor disposed in the mobile communication device having a display. A word and word string database, a word and word string similarity comparator for comparing the speech input word and word string pronunciations in the databases, and a selector for selecting a sequence of associations between the input speech and the words and word strings in their respective databases, are disposed in servers at network communications sites. The selected words and word strings are transmitted to the mobile communication device display for displaying the selected words and word strings for confirmation by scrolling, highlighting, and final selecting and transmission. The invention is particularly applicable for mobile wireless Internet communications.

### FIELD OF THE INVENTION

This invention relates generally to speech recognition systems and more specifically to a speech recognition system for mobile Internet/Intranet communications.

### BACKGROUND OF THE INVENTION

Transmission of information from humans to machines has been traditionally achieved though manually-operated keyboards, which presupposes machines having dimensions at least as large as the comfortable finger-spread of two human hands. With the advent of electronic devices requiring information input but which are smaller than traditional personal computers, the information input began to take other forms, such as menu item selection by pen pointing and icon touch screens. The information capable of being transmitted by pen-pointing and touch screens is limited by the display capabilities of the device (such as personal digital assistants (PDAs) and mobile phones). Therefore, speech recognition systems for electronic devices have been the object of significant research effort.

Typical automatic speech recognition systems sample points for a discrete Fourier transform calculation or filter bank, or other means of determining the amplitudes, of the component waves of a speech signal. The parameterization of speech waveforms generated by a microphone is based upon the fact that any wave can be represented by a combination of simple sine and cosine waves; the combination of waves being given most elegantly by the Inverse Fourier Transform:

$$g ( t ) = \frac{1}{2 π} {\int }_{- ∞}^{∞} G ( t ) {ⅇ}^{ⅈ2π f t} ⅆ f$$

where the Fourier Coefficients are given by the Fourier Transform

$$G ( f ) = {\int }_{- ∞}^{∞} g ( t ) {ⅇ}^{- ⅈ2π f t} ⅆ t$$

which gives the relative strengths of the components of the wave at a frequency f; that is, the spectrum of the wave in frequency space. Since a vector also has components which can be represented by sine and cosine functions, a speech signal can also be described by a spectrum vector. For actual calculations, the discrete Fourier transform can be used:

$$G ( \frac{n}{τ N} ) = {\sum }_{k = 0}^{N - 1} [ τ \cdot g ( k τ ) {ⅇ}^{- ⅈ2π k \frac{n}{N}} ]$$

where k is the placing order of each sample value taken, τ is the interval between values read, and N is the total number of values read (the sample size). Computational efficiency is achieved by utilizing the fast Fourier transform (FFT) which performs the discrete Fourier transform calculations using a series of shortcuts based on the circularity of trigonometric functions.

Conventional speech recognition systems have parameterized the acoustic features utilizing the cepstrum, c(n), a set of cepstral coefficients, of a discrete-time signal s(n) which is defined as the inverse discrete-time Fourier transform (DTFT) of the log spectrum

$$c ( n ) = \frac{1}{2 π} {\int }_{- π}^{π} log [ S ( {ⅇ}^{ⅈω} ) ] {ⅇ}^{ⅈω n} ⅆ ω$$

Fast Fourier transform and linear predictive coding (LPC) spectral analysis have been used to derive the cepstral coefficients. In addition, the perceptual aspect of speech features has been conveyed by warping the spectrum in frequency to resemble a human auditory spectrum. Thus typical speech recognition systems utilize cepstral coefficients obtained by integrating the outputs of a frequency-warped FFT filterbank to model non-uniform resolving properties of human hearing.

Linear predictive coding (LPC) performs spectral analysis on frames of speech generating a vector of coefficients that parametrically specify the spectrum of a model to match the signal spectrum over the period of time of the sample frame of the speech. The conventional LPC cepstrum is derived from the LPC parameters a(n) using the recursion relation

c(0)=1n G²

$$c ( n ) = a ( n ) + \frac{1}{n} {\sum }_{k = 1}^{n - 1} kc ( k ) a ( n - k )$$

where n>0. Conventional speech recognition systems utilizing LPC are well-developed in the art.

In the pattern-recognition approach, a knowledge base of versions of a given speech pattern is assembled (“training”), and recognition is achieved through comparison of the input speech pattern with the speech patterns in the knowledge base to determine the best match. The paradigm has four steps: (1) feature extraction using spectral analysis, (2) pattern training to produce reference patterns for an utterance class, (3) pattern classification to compare unknown test patterns with the class reference pattern by measuring the spectral ”distance” (or distortion) between two well-defined spectral vectors and aligning the time to compensate for the different rates of speaking of the two patterns (dynamic time warping, DTW), and (4) decision logic whereby similarity scores are utilized to select the best match. Pattern recognition requires heavy computation, particularly for steps (2) and (3) and pattern recognition for large numbers of sound classes often becomes prohibitive.

Systems relying on the human voice for information input, because of the inherent vagaries of speech (including homophones, word similarity, accent, sound level, syllabic emphasis, speech pattern, background noise, and so on), require considerable signal processing power and large look-up table databases in order to attain even minimal levels of accuracy. Mainframe computers and high-end workstations are beginning to approach acceptable levels of voice recognition, but even with the memory and computational power available in present personal computers (PCs), speech recognition for those machines is so far largely limited to given sets of specific voice commands. For devices with far less memory and processing power than PCs, such as PDAs, mobile phones, toys, and entertainment devices, accurate recognition of natural speech has been hitherto impossible. For example, a typical voice-activated cellular phone allows preprogramming by reciting a name and then entering an associated number. When the user subsequently recites the name, a microprocessor in the cell phone will attempt to match the recited name's voice pattern with the stored number. As anyone who has used present day voice-dial cell phones knows, the match is often inaccurate and only about 25 stored numbers are possible. In PDA devices, it is necessary for device manufacturers to perform extensive redesign to achieve even very limited voice recognition (for example, present PDAs cannot search a database in response to voice input).

Since conventional recognition relies on a simple accumulated distortion score over the entire utterance duration (a binary “yes” or “no”), the word “recognized” is either correct or incorrect resulting in poor overall performance of the recognition system..

Of particular present day interest is mobile Internet access; that is, communication through mobile phones, PDAs, and other hand-held electronic devices to the Internet. The Wireless Application Protocol (WAP) specification is intended to define an open, standard architecture and set of protocols for wireless Internet access. WAP consists of the Wireless Application Environment (WAE), the Wireless Session Protocol (WSP), the Wireless Transport Protocol (WTP), and the Wireless Transport Layer Security (WLS). WAE displays content on the screen of the mobile device and includes the Wireless Markup Language (WML), which is the presentation standard for mobile Internet applications. WAP-enabled mobile devices include a microbrowser to display WML content. WML is a modified subset of the Web markup language Hypertext Markup Language (HTML), scaled appropriately to meet the physical constraints and data capabilities of present day mobile devices, for example the Global System for Mobile (GSM) phones. Typically, the HTML served by a Web site passes through a WML gateway to be scaled and formatted for the mobile device. The WSP establishes and closes connections with WAP web sites, the WTP directs and transports the data packets, and the WLS compresses and encrypts the data sent from the mobile device. Communication from the mobile device to a web site that supports WAP utilizes the Universal Resource Locators (URL) to find the site, is transmitted via radio waves to the nearest cell and routed through the Internet to a gateway server. The gateway server translates the communication content into the standard HTTP format and transmits it to the web site. The web site response returns HTML documents to the gateway server which converts the content to WML and routes to the nearest antenna which transmits the content via radio waves to the mobile device. The content available for WAP currently includes email, news, weather, financial information, book ordering (Amazon), investing services (Charles Schwab), and other information. Mobile phones with built-in Global Positioning System (GPS) receivers can pinpoint the mobile device user's position so that proximate restaurant and navigation information can be received.

Mobile wireless Internet access is widespread in Japan and Scandinavia and demand is steadily increasing elsewhere. Efficient mobile Internet access, however, will require new technologies. Data transmission rate improvements such as the General Packet Radio Service (GPRS), Enhanced Data Rates for GSM Evolution (EDGE), and the Third Generation Universal Mobile Telecommunications System (3G-UMTS) are underway. But however much the transmission rates and bandwidth increase, how well the content is reduced or compressed, and the display capabilities modified, the vexing problem of information input and transmission at the mobile device end has not been solved. For example, just the keying in of a website's (often very obscure) URL is a tedious and error-prone exercise.

### SUMMARY OF THE INVENTION

There is a need, therefore, for an accurate speech recognition system operable for hand-held devices. Such a system must therefore have relatively low computational power and memory requirements, low power consumption, simple operating systems, low weight and low cost. This invention provides accurate speech recognition for electronic devices with low processing power and limited memory storage capability. Basic accuracy is achieved by the utilization of specialized and/or individualized dictionary databases comprising several thousand words appropriate for specific uses such as website locating and professional/commercial lexicons. Further accuracy is achieved by first recognizing individual words and then matching aggregations of those words with word string databases. Still further accuracy is achieved by the use of processors and databases that are located at the telecommunications sites. Almost total accuracy is achieved by a scrolling selection system of candidate words. The invention comprises a microphone and a front-end signal processor disposed in the mobile communication device having a display. A word and word string database, a word and word string similarity comparator for comparing the speech input word and word string pronunciations in the databases, and a selector for selecting a sequence of associations between the input speech and the words and word strings in their respective databases, are disposed in servers at network communications sites. The selected words and word strings are transmitted to the mobile communication device display for displaying the selected words and word strings for confirmation by scrolling, highlighting, and final selecting and transmission. The invention is particularly applicable for mobile wireless Internet communications.

### BRIEF DESCRIPTIONS OF THE DRAWINGS

FIG. 1 is a block diagram of the speech recognition system for individual words according to the present invention.

FIG. 2 is a schematic drawing of a display for displaying the match sequence of words according to the present invention.

FIG. 3 is a block diagram of the speech recognition system for word strings according to the present invention.

FIG. 4 is a block diagram of an LPC front-end processor according to the present invention.

FIG. 5 is a block diagram of an embodiment of a word similarity comparator according to the present invention.

FIG. 6 is the dynamic time warping initialization flowchart procedure for calculating the Total Distortion cepstrum according to the present invention.

FIG. 7 is the dynamic time warping iteration procedure flowchart for calculating the Total Distortion cepstrum according to the present invention.

FIG. 8 is the dynamic time warping flowchart for calculating the relative values of the Total Distortion cepstrum according to the present invention.

FIG. 9 is a schematic diagram of one embodiment of the speech recognition system for Internet/Intranet networks according to the present invention.

FIG. 10 is a schematic diagram illustrating the confirmation system of either the website name or the speech according to the present invention.

### DETAILED DESCRIPTION OF THE INVENTION

A preferred embodiment of the present invention recognizes individual words by comparison to parametric representations of specialized predetermined words in a database. The closest comparisons are selected and displayed in sequence according to closeness of the match, whereupon a user may scroll through the sequence and select the correctly recognized word. Another preferred embodiment of the invention recognizes word strings based upon the aggregation of selected parametric representations of the individual words in the word database, makes the comparisons with the word strings in the word string database, and generates a sequence of best matches. For example, the individual words “new”, “york”, “stock”, and “exchange” when aggregated into a word string forms a specific, different meaning from its constituent words: “New York Stock Exchange”. This latter embodiment is particularly suitable for languages wherein the pronunciation of individual words, when aggregated into word strings, do not change their pronunciation. For example, in English the word “computer” when pronounced is different from the pronunciation of its constituent letters, but in Chinese, computer is pronounced “dian-nao” which is the same pronunciation as its constituent characters “dian” and “nao”. This is true for other languages as well, for example Korean and Japanese. The selected sequence of best word string matches is displayed at the user end for scrolling and selecting.

One embodiment of the present invention separates the microphone, front-end signal processing, and display at a mobile device, and the speech processors and databases at servers located at communications sites, thereby achieving high speech recognition accuracy for small devices. In the preferred embodiment, the front-end signal processing performs feature extraction which reduces the required bit rate to be transmitted. Further, because of error correction performed by data transmission protocols, recognition performance is enhanced as opposed to conventional voice portals where recognition may suffer serious degradation over transmission (e.g., as in early-day long-distance calling). Thus, the invention is advantageously applicable for the Internet or intranet systems. Other uses include electronic games and toys, entertainment appliances, and any computers where voice input is desired.

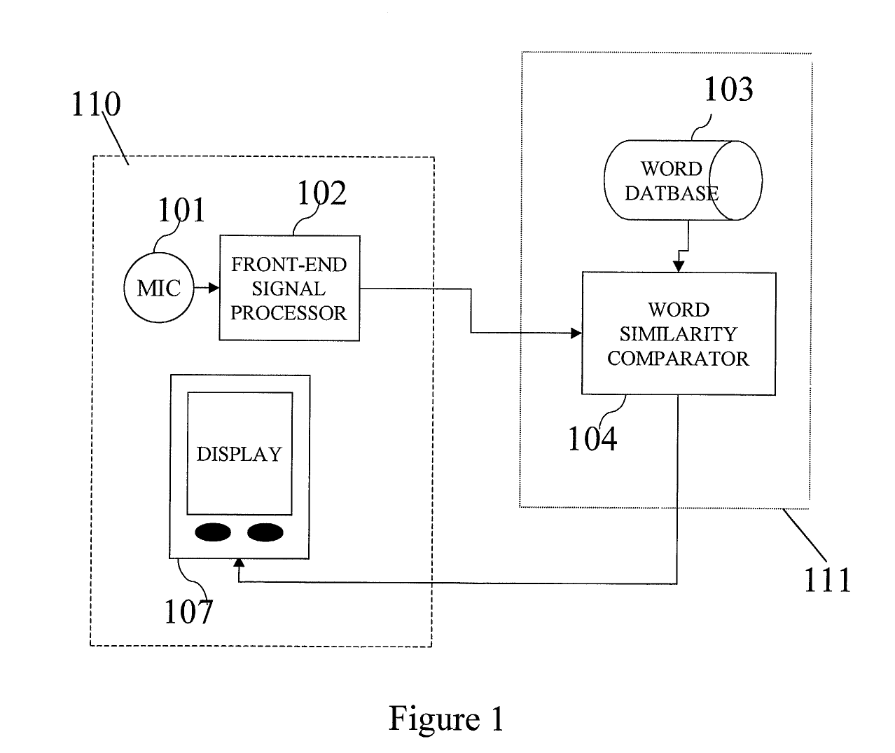

FIG. 1 is a block diagram of a preferred embodiment of the speech recognition system for individual words. A microphone 101 receives an input speech which is transmitted to front-end signal processor 102 to form a parameterized speech waveform which is then compared with the prerecorded parameterized words in word database 103 utilizing a word similarity comparator 104 to select the best matches. The present invention contemplates pre-recorded word databases consisting of specialized words for specific areas of endeavor (commercial, business, service industry, technology, academic, and all professions such as legal, medical, accounting, and so on) and particular vocabularies useful for email or chat communications. Through comparison of the pre-recorded waveforms in word database 103 with the input speech waveforms, a sequential set of phonemes is generated that are likely matches to the spoken input. A “score” value is assigned based upon the closeness of each word in word database 103 to the input speech. The “closeness” index is based upon a calculated distortion between the input waveform and the stored word waveforms, thereby generating “distortion scores”. Since the scores are based on specialized word dictionaries, they are relatively more accurate. The best matches for the words are then displayed on display 107 in sequence of closest match. The words can be polysyllabic and can be terms or phrases depending on the desired application. That is, a phrase such as “Dallas Cowboys” or “Italian restaurants” can be recognized as well as complete sentences comprising the individual words. In the preferred embodiment, microphone 101 and front-end signal processor 102 are disposed together as 110 on, for example, a mobile phone which has a display 107. Word database 103 and word similarity comparator 104 are disposed at a telecommunications carrier site or website in, for example, a server represented by 111. In this way, the present invention provides greater storage and computational capability through server 111, which in turn allows more accurate and broader range speech recognition. The mobile device need only include a less complex front-end signal processor 102. If the mobile device is a cell phone, it already has a microphone and display. If the mobile device is a PDA, it need only add a microphone and the front-end signal processor.

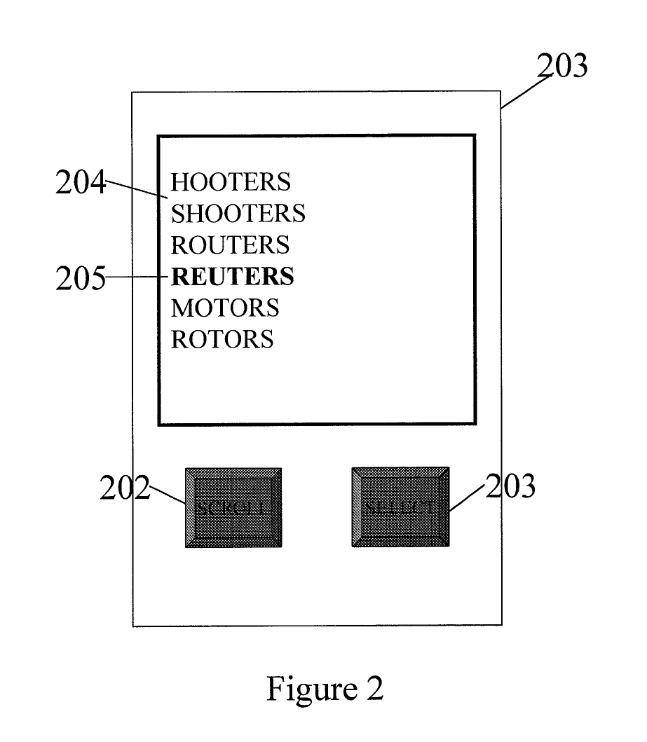

FIG. 2 is a schematic drawing of a display 201 for displaying the match sequence of words according to the present invention. A scroll button 202 allows the user to scroll through the word matches 204 with a highlighting of each word. A select button 203 allows the user to select the word. The implementation and operation of the scrolling, highlighting, and selection functions in computers and mobile communications devices such as cell phones and PDAs for uses other than speech recognition are known to those in the art.

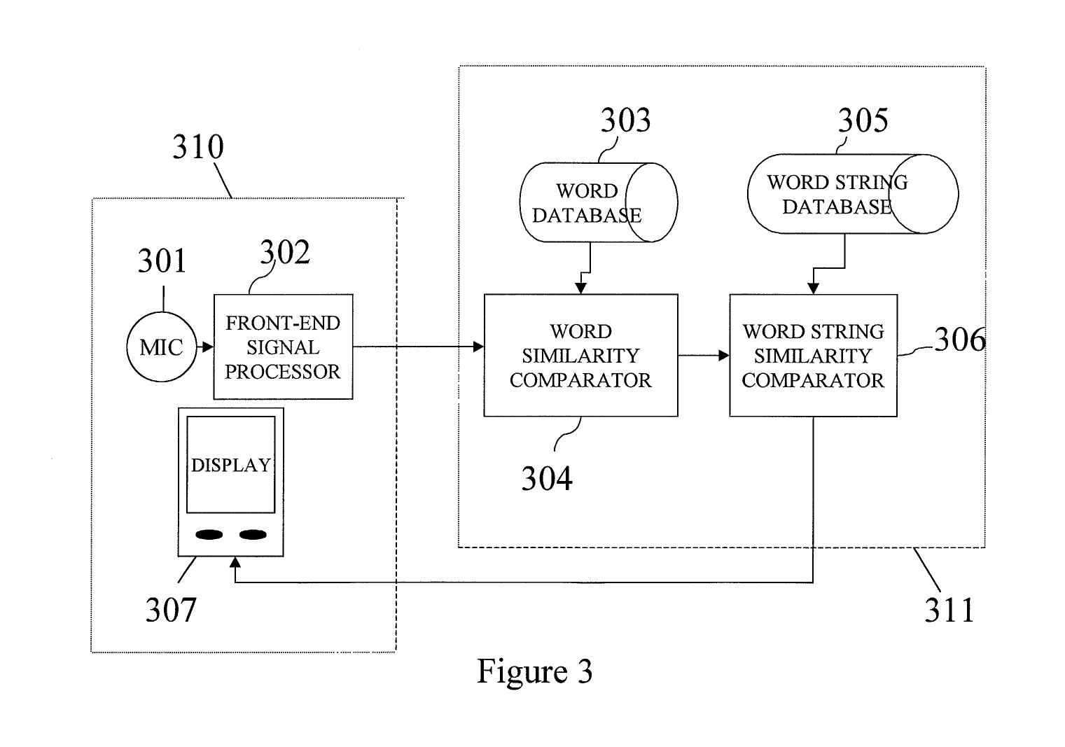

FIG. 3 is a block diagram of a preferred embodiment of the present invention for word strings, showing a microphone 301 coupled to a front-end signal processor 302 for parameterizing an input speech. Word similarity comparator 304 is coupled (or includes) a word database 303 containing parametric representations of words which are to be compared with the input speech words. In the preferred embodiment of the present invention, words from word database 303 are selected and aggregated to form a waveform string of aggregated words. This waveform string is then transmitted to word string similarity comparator 306 which utilizes a word string database 305 to compare the aggregated waveform string with the word strings in word string database 305. The individual words can be, for example, “burger king” or “yuan dong bai huo” (“Far Eastern Department Store” in Chinese) which aggregate is pronounced the same as the individual words. Other examples include the individual words like “mi tsu bi si” (Japanese “Mitsubishi”) and “sam sung” (Korean “Samsung”) which aggregate also is pronounced the same as the individual words. In the preferred embodiment, microphone 301 and front-end signal processor 302 are disposed together as 310 on, for example, a mobile phone which has a display 307. Word database 303, word similarity comparator 304, word string database 305, and word string similarity comparator 306 are disposed at a telecommunications carrier site or website in, for example, a server represented by 311. In this way, the present invention provides greater storage and computational capability through the server 311, which allows more accurate and broader range speech recognition. The mobile device need only include a less complex front-end signal processor 302. If the mobile device is a cell phone, it already has a microphone and display. If the mobile device is a PDA, it need only add a microphone and the front-end signal processor. Display 307 has the same scrolling, highlighting, and selection functions described above.

In the preferred embodiment of the invention, front-end signal processors 102 and 302 utilize linear predictive coding (LPC). LPC offers a computationally efficient representation that takes into consideration vocal tract characteristics (thereby allowing personalized pronunciations to be achieved with minimal processing and storage).

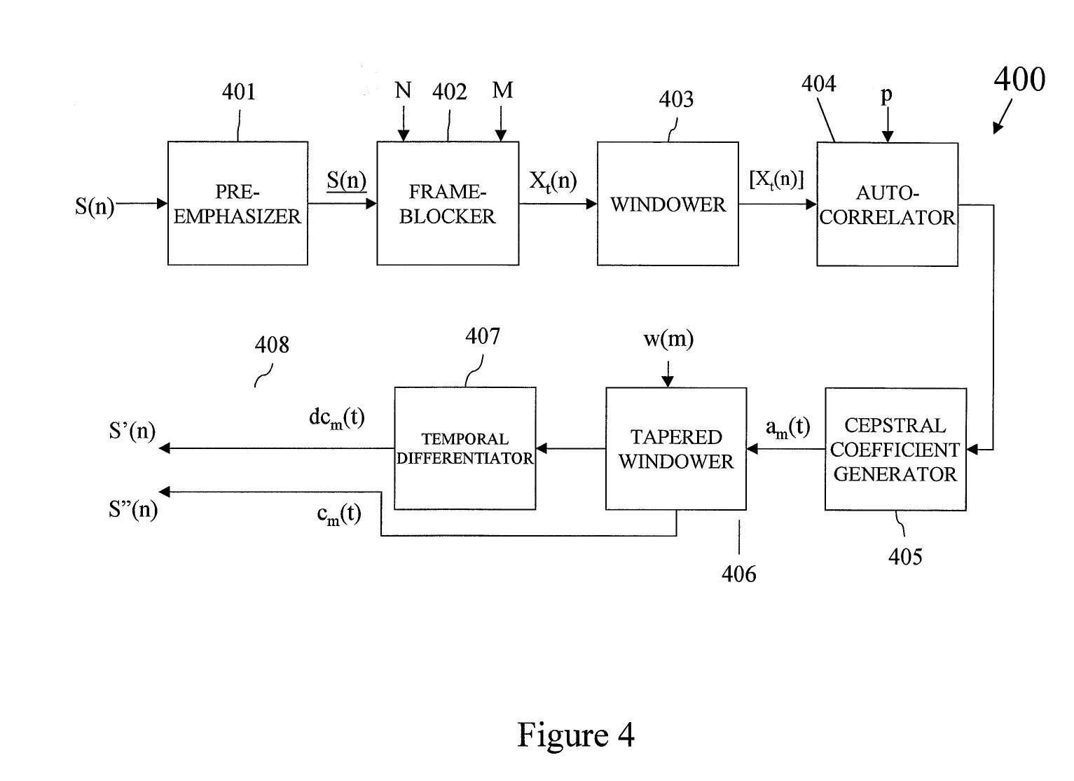

FIG. 4 is a block diagram of an LPC front-end processor 102 according to the preferred embodiment of the invention. A pre-emphasizer 401 which preferably is a fixed low-order digital system (typically a first-order FIR filter) spectrally flattens the signal s(n), and is described by:

P(z)=1−az⁻¹ (Eqn 1)

where 0.9≦a≦1.0. In another embodiment of the invention, pre-emphasizer 401 is a first-order adaptive system having the transfer function

P(z)=1−aₙz⁻¹ (Eqn 2)

where aₙ changes with time (n) according to a predetermined adaptation criterion, for example, aₙ=rₙ(1)/rₙ(0) where rₙ(i) is the i^{th} sample of the autocorrelation sequence. Frame blocker 402 frame blocks the speech signal in frames of N samples, with adjacent frames being separated by M samples. In this embodiment of the invention, N=M=160 when the sampling rate of the speech is 8 kHz, corresponding to 20 msec frames with no separation between them. There is one feature per frame so that for a one second utterance (50 frames long), 12 parameters represent the frame data, and a 50×12 matrix is generated (the template feature set). Windower 403 windows each individual frame to minimize the signal discontinuities at the beginning and end of each frame. In the preferred embodiment of this invention, where M=N, a rectangular window is used to avoid loss of data at the window boundaries. Autocorrelator 404 performs autocorrelation giving

$${r}_{1} ( m ) = {\sum }_{n = 0}^{N - 1 - m} {x}_{1} ( n ) {x}_{1} ( n + m ) \qquad ( Eqn 3 )$$

where m=0, 1, . . . , p, and p is the order of the LPC analysis. The preferred embodiment of this invention uses p=10, but values of p from 8 to 16 can also be advantageously used in other embodiments and other values to increase accuracy are also within the contemplation of this invention. The zeroth autocorrelation is the frame energy of a given frame. Cepstral coefficient generator 405 converts each frame into cepstral coefficients (the inverse Fourier transform of the log magnitude spectrum, refer below) using Durbin's method, which is known in the art. Tapered cepstral windower 406 weights the cepstral coefficients in order to minimize the effects of noise. Tapered windower 406 is chosen to lower the sensitivity of the low-order cepstral coefficients to overall spectral slope and the high-order cepstral coefficients to noise (or other undesirable variability). Temporal differentiator 407 generates the first time derivative of the cepstral coefficients preferably employing an orthogonal polynomial fit to approximate (in this embodiment, a least-squares estimate of the derivative over a finite-length window) to produce processed signal S′(n). In another embodiment, the second time derivative can also be generated by temporal differentiator 407 using approximation techniques known in the art to provide further speech signal information and thus improve the representation of the spectral properties of the speech signal. Yet another embodiment skips the temporal differentiator to produce signal S″(n). It is understood that the above description of the front-end signal processors 102 and 302 using LPC and the above-described techniques are for disclosing the best embodiment, and that other techniques and methods of front end signal processing can be advantageously employed in the present invention.

The comparison techniques and methods for matching utterances, be they words or word strings, are substantially similar, so the following describes the techniques utilized in the preferred embodiment of both comparators 304 and 306 of FIG. 3.

In the preferred embodiment of the present invention, the parametric representation is by cepstral coefficients and the inputted speech is compared with the word pronunciations in the prerecorded databases, by comparing cepstral distances. The inputted words or characters or word strings generate a number of candidate word and word string matches which are ranked according to similarity. In the comparison of the pre-recorded waveforms with the input waveforms, a sequential set of phonemes that are likely matches to the spoken input are generated which, when ordered in a matrix, produces a phoneme lattice. The lattice is ordered by assigning, for each input speech waveform, a “score” value of the candidate words in the word and word string databases, based upon the closeness of each input speech waveform to words and word strings in the vocabulary databases. The “closeness” index is based upon the cepstral distance between the input speech waveform and the stored vocabulary waveforms, thereby generating “distortion scores”.

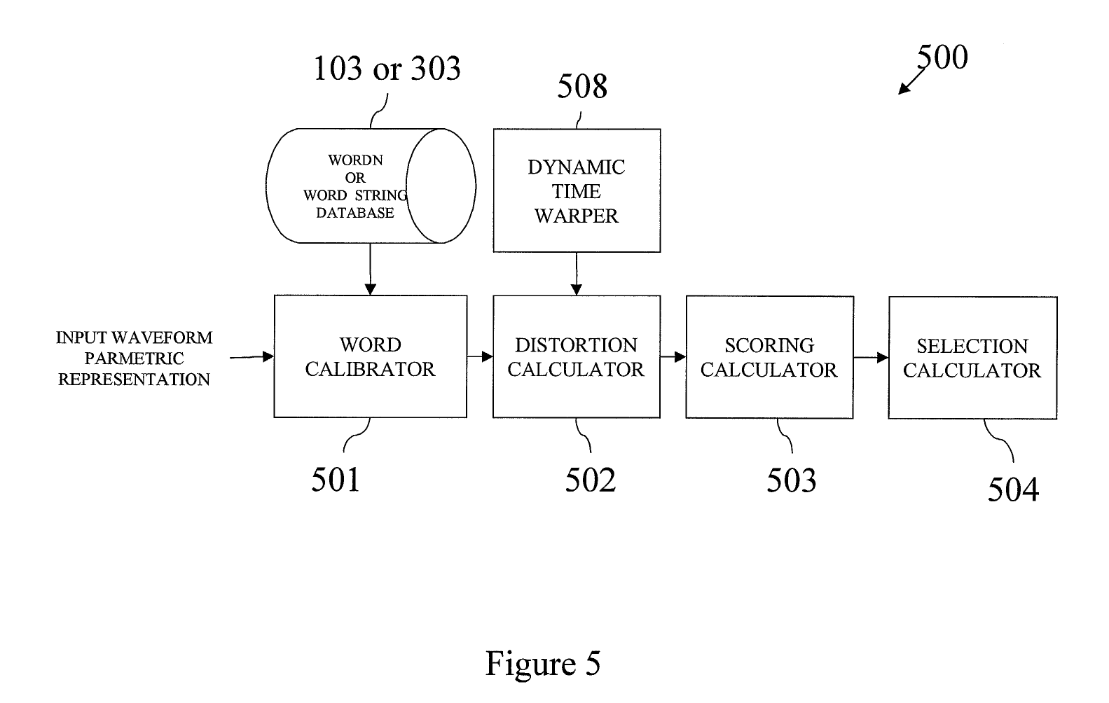

FIG. 5 is a block diagram of an embodiment of a word similarity comparator 500 according to the present invention. A waveform parametric representation is inputted to word calibrator 501 wherein, in conjunction with word database 103 or 303, a calibration matrix is generated. Distortion calculator 502 calculates the distortion between the inputted speech and the entries in word database 103 or 303 based on, in the preferred embodiment, the cepstral distances described below. Scoring calculator 503 then assigns scores based on predetermined criteria (such as cepstral distances) and selector 504 selects the candidate words or word strings. The difference between two speech spectra on a log magnitude versus frequency scale is

V(ω)=log S(ω)−log S′(ω). (Eqn 4)

In the preferred embodiment, to represent the dissimilarity between two speech feature vectors, the preferred embodiment utilizes the mean absolute of the log magnitude (versus frequency), that is, a root mean squared (rms) log spectral distortion (or “distance”) measure utilizing the set of norms

$${d ( S , {S}^{′} )}^{p} = {\int }_{- π}^{π} \vert V ( ω ) {\vert}^{p} ⅆ ω / 2 π \qquad ( Eqn 5 )$$

where when p=1, this is the mean absolute log spectral distortion and when p=2, this is the rms log spectral distortion. In the preferred embodiment, the distance or distortion measure is represented by the complex cepstrum of a signal, which is defined as the Fourier transform of the log of the signal spectrum. For a power spectrum which is symmetric with respect to ω=0 and is periodic for a sampled data sequence, the Fourier series representation of log S(ω) is

$$log S ( ω ) = {\sum }_{n = - ∞}^{∞} {c}_{n} {ⅇ}^{- j n ω} \qquad ( Eqn 6 )$$

where cₙ=c₋ₙ are the cepstral coefficients.

$${c}_{0} = {\int }_{- π}^{π} log S ( ω ) ⅆ ω / 2 π \qquad ( Eqn 7 )$$

$${d ( S , {S}^{′} )}^{2} = {\int }_{- π}^{π} {\vert log S ( ω ) - log {S}^{′} ( ω ) \vert}^{2} ⅆ ω / 2 π = {\sum }_{n = - ∞}^{∞} {( {c}_{n} - {c}_{n}^{′} )}^{2} \qquad ( Eqn 8 )$$

where cₙ and cₙ′ are the cepstral coefficients of S(ω) and S′(ω), respectively. By not summing infinitely, for example 10-30 terms in the preferred embodiment, the present invention utilizes a truncated cepstral distance. This efficiently (meaning relatively lower computation burdens) estimates the rms log spectral distance. Since the perceived loudness of a speech signal is approximately logarithmic, the choice of log spectral distance is well suited to discern subjective sound differences. Furthermore, the variability of low cepstral coefficients is primarily due to vagaries of speech and transmission distortions, thus the cepstrum (set of cepstral distances) is advantageously selected for the distortion measure. Different acoustic renditions of the same utterance are often spoken at different time rates so speaking rate variation and duration variation should not contribute to a linguistic dissimilarity score. Dynamic time warper (DTW) 508 performs the dynamic behavior analysis of the spectra to more accurately determine the dissimilarity between the input speech and the matched database words and word strings. DTW 508 time-aligns and normalizes the speaking rate fluctuation by finding the “best” path through a grid mapping the acoustic features of the two patterns to be compared. In the preferred embodiment, DTW 508 finds the best path by a dynamic programming minimization of the dissimilarities. Two warping functions, φₓ and φ_{y}, relate two temporal fluctuation indices, iₓ and i_{y} respectively, of the speech pattern to a common time axis, k, so that

iₓ=φ_{x(k),}

i_{y=φ}_{y(K)}

k=1,2, . . . ,T

K=1,2, . . . ,T. (Eqn 9)

A global pattern dissimilarity measure is defined, based on the warping function pair, as the accumulated distortion over the entire utterance:

$${d}_{ϕ} ( X , Y ) = {\sum }_{k = 1}^{T} d ( {ϕ}_{x} ( k ) , {ϕ}_{y} ( k ) ) m ( k ) / {M}_{ϕ} \qquad ( Eqn 10 )$$

where d(φₓ(k), φ_{y}(k)) is a short-time spectral distortion defined for x_{φx(k)}y_{φy(k)}, m(k) is a nonnegative weighting function, M_{φ} is a normalizing factor, and T is the “normal” duration of two speech patterns on the normal time scale. The path φ=(φₓ,φ_{y}) is chosen so as to measure the overall path dissimilarity with consistency. In the preferred embodiment of the present invention, the dissimilarity d(X,Y) is defined as the minimum of d_{φ}(X,Y) over all paths, i.e.,

$$d ( X , Y ) = {min}_{ϕ} {d}_{ϕ} ( X , Y ) \qquad ( Eqn 11 )$$

The above definition is accurate when X and Y are utterances of the same word because minimizing the accumulated distortion along the alignment path means the dissimilarity is measured based on the best possible alignment to compensate for speaking rate differences. In one embodiment of the present invention, since the number of steps involved in the move are determined by “if-then” statements, the sequential decision is asynchronous. The decision utilizes a recursion relation that allows the optimal path search to be conducted incrementally and is performed by an algorithm as described immediately below.

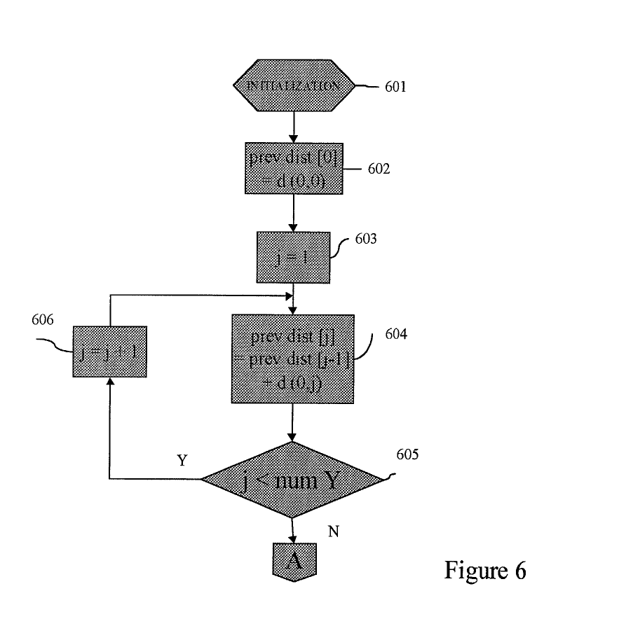

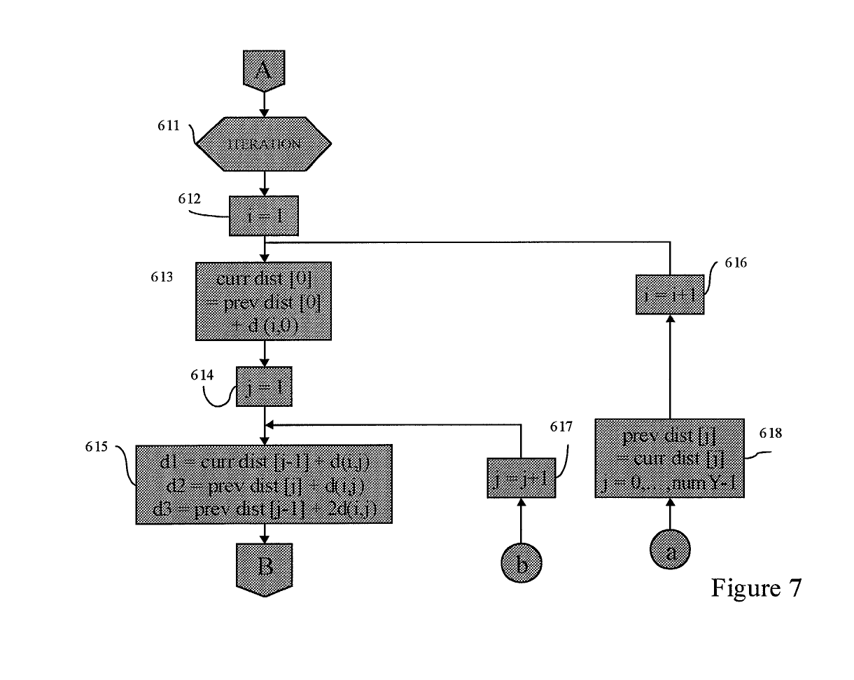

FIGS. 6, 7, and 8, constitute a flow chart of the preferred embodiment of DTW 408 for computing the Total Distortion between templates to be compared. The “distance” d(i,j) (Eqn. (11) above) is the distortion between the i^{th} feature of template X and the j^{th} feature of template Y. FIG. 6 depicts the initialization procedure 601 wherein the previous distance is d(0,0) at 602. The index j is then incremented at 603 and the previous distance now is the distance at j (prev dist[j] which is equal to prev dist [j−1]+d(0,j). At 605, if j is less than number of features in template Y (j<num Y), then j will be incremented at 606 and fed back to 604 for a new calculation of prev dist[j]. If j is not greater than num Y, then the initialization is complete and the Iteration Procedure 611 for the Total Distortion begins as shown in FIG. 7. At 612, i is set at one and the current distance (curr dist[0]) is calculated as the prev dist[0] plus d(i,0). At 614, j is set to one and the possible paths leading to an associated distance d1, d2, or d3 are calculated as:

curr dist[j−1]+d(i,j)=d1

prev dist[j]+d(i,j)=d2

prev dist[j−1]+d(i,j)=d3.

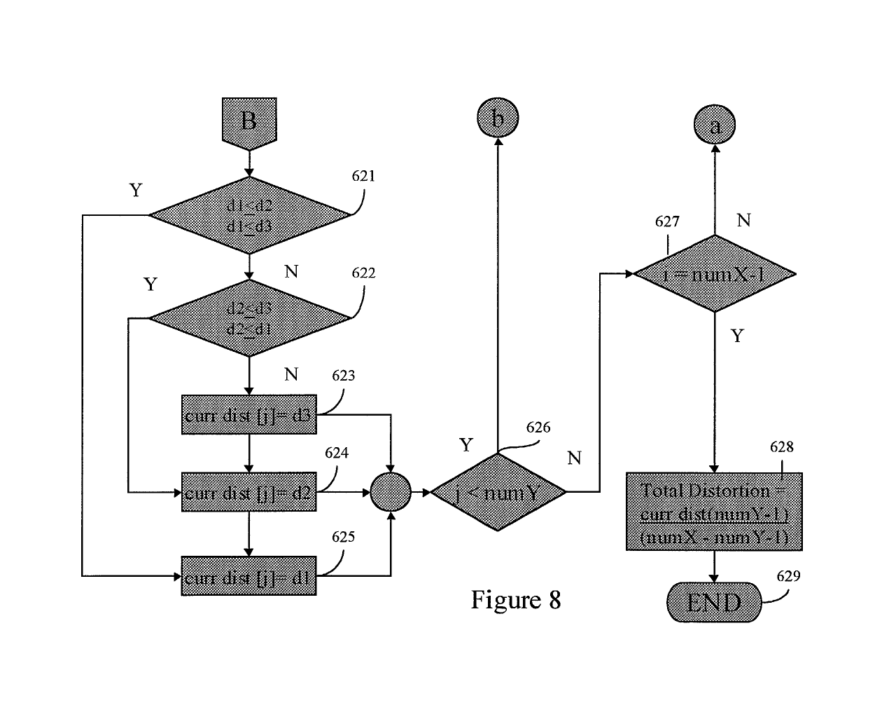

The relative values of the associated distances are then tested at 621 and 622 in FIG. 8. If d3 is not greater than d1 and not greater than d2, then d3 is the minimum and curr dist[j] will be d3 at 623. After testing for the j^{th} feature as less than the number of features in the Y template at 626, then j is incremented at 617 and fed back to the calculation of distances of possible paths and the minimization process recurs. If d2 is greater than d1 and d3 is greater than d1, then d1 is the minimum and is thus set as the curr dist[j]. Then j is again tested against the number of features in the Y template at 626, j is incremented at 617 and fed back for recursion. If d3 is greater d2 and d1 is greater than d2, then d2 is the minimum and is set as the curr dist[j] and the like process is repeated to be incremented and fed back. In this way, the minimum distance is found. If j is greater than or equal to the number of features in template Y at 626, then i is tested to see if it is equal to the number of features in template X minus 1. If i is not equal to the number of features in template X minus 1, then the previous distance is set as the current distance for the j indices (up to num Y−1) at 618, i is incremented at 616 and fed back to 613 for the setting of the current distance as the previous distance plus the new i^{th} distance and the process is repeated for every i up the time j equals the number of features in template X minus 1. If i is equal to the number of features in the X template minus 1, then the Total Distortion is calculated at 628 as

$$Total Distortion = \frac{curr\_dist ( numY - 1 )}{( numY - numY - 1 )} ,$$

thus completing the algorithm for finding the total distortion.

Even small speech endpoint errors result in significant degradation in speech detection accuracy. In carefully-enunciated speech in controlled environments, high detection accuracy is attainable, but for general use (such as in cell phones), the vagaries of the speaker sounds (including lip smacks, breathing, clicking sounds, and so on) and background noise make accurate endpoint detection difficult. If the endpoints (marking the beginning and ending frames of the pattern) are determined accurately, the similarity comparisons will be more accurate. One embodiment of the present invention utilizes an endpoint determination technique which is the subject of another patent application assigned to the assignee of this invention.

In operation, a user may use the speaker-independent input default mode whereby a pre-recorded word database for speech recognition is used. In an embodiment of the invention, a menu selection allows the user to choose male or female voice recognition and language selection. Word database 103 and word string database 303 include prerecorded templates for male or female voices or different languages. If the user records his/her own voice in his/her selected language, this will be recorded in word database 103 and/or word string database 303.

It is particularly noted herein that the present invention is ideal for processing the words and word strings in languages such as English, but particularly for the Chinese, Japanese, and Korean languages. The present invention provides a highly accurate recognition of individual words, which when taken in aggregate to form a word string, produces even more accurate recognition because of the more limited number of sensical choices.

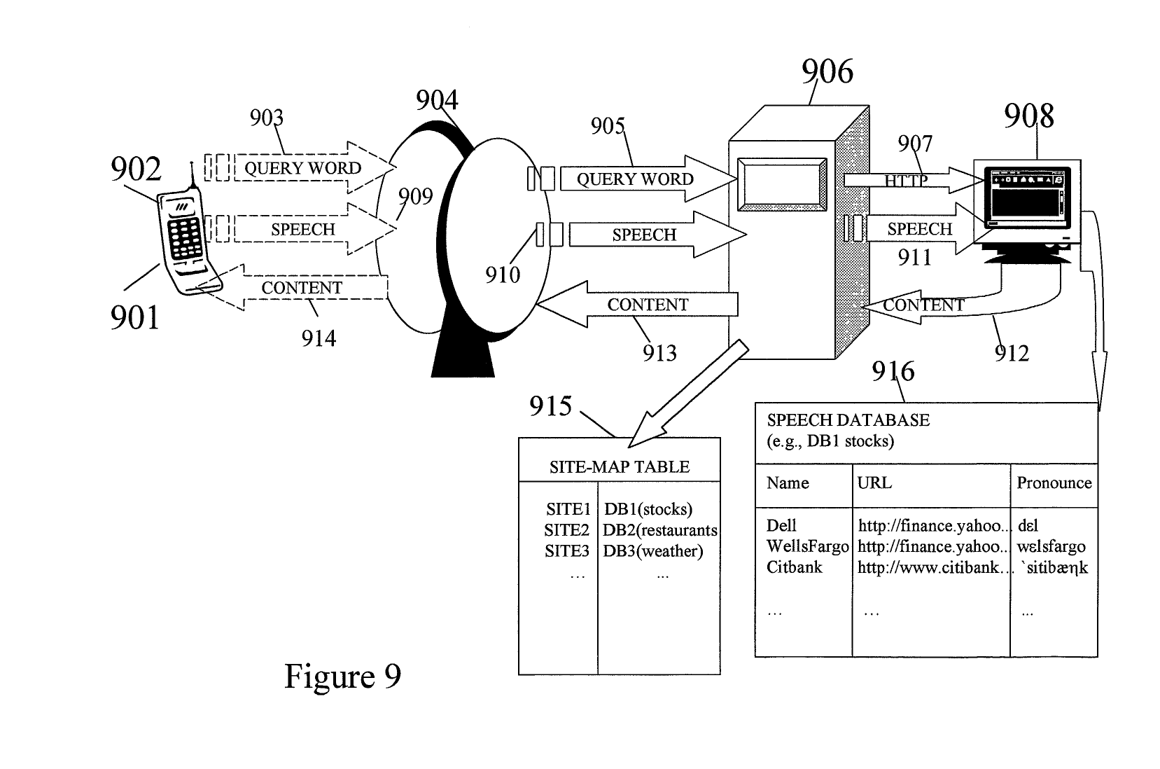

The present invention contemplates particularly advantageous application in mobile communication with the Internet, for example through the Wireless Application Protocol (WAP). FIG. 9 is a schematic diagram of one embodiment of the VerbalWAP™ system according to the present invention. A mobile communication device, for example a cell phone, 901 includes a hot key 902 which engages the speech communication system of the present invention. For each speech session, hot key 902 is pressed. A query word or words are spoken for a given category, for example “stocks”. The present invention's front-end signal processors (102 and 302 in FIGS. 1 and 3 respectively) extracts features from the input speech word(s), for example, the LPC cepstrum, and transmits the digitized speech parameters via packet 903 to antenna array 904 which relays it to gateway server 906 wherein a speech recognition system according to the present invention recognizes the digitally parameterized query word as Sitel and maps to DB1 in the Site Map Table 915. It is understood that other acoustic parameters (such as pitch, speaker proclivities, etc.) can be transmitted as well, to improve speech recognition accuracy at server 906. A microbrowser (e.g., UP.browser, Mobile Explorer, etc.) can be utilized to automatically locate the appropriate site/portal, and the connection 907 is established in HTTP for Sitel (for example, Database 1, DB1 on Site Map Table 915), the database for stocks information. “Stocks” can be shown on the display of cell phone 901 for verification. The user then presses hot key 902 again for speech capability, and pronounces the name of the stock, e.g., “dε1” which is transmitted to a speech via packet 909 to antenna array 904 which relays the packet 910 to gateway server 906 which transmits the speech to content site 908 where speech database 916 maps the pronounced speech to the appropriate URL (in this example, http://finance.yahoo.com). The word “Dell” is recognized by the present invention at content site 908, and for example, Dell's share price, high, low, and volume is transmitted via content packet 912 to gateway server 906 and then via packet 913 to antenna array 904 and back to the user at mobile device 901. It is understood that any language and any words or word strings can be used depending on the word and word string databases and any content can be provided by the site depending on the contents of the databases DB1, DB2, etc.

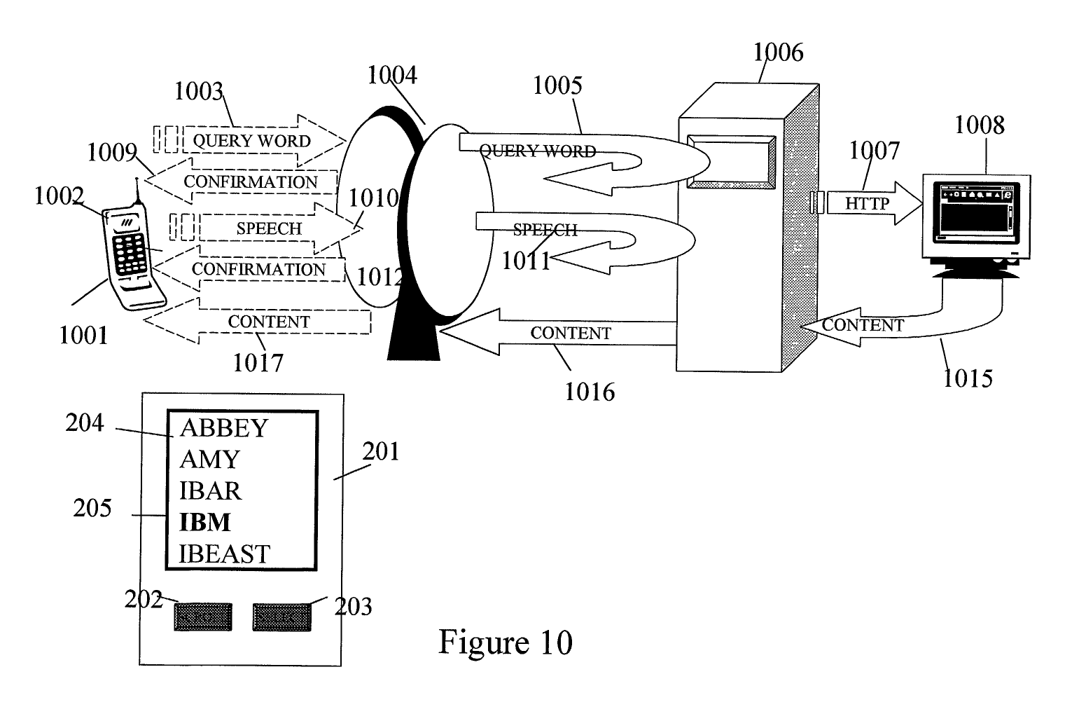

FIG. 10 is a schematic diagram illustrating another embodiment of the present invention whereby either the query word or the speech or both can be confirmed for speech recognition accuracy. A user at mobile phone 1001 presses hot key 1002 and voice inputs a query word and a digitally parameterized query word packet 1003 is transmitted to antenna array 1004 which transmits the query word via packet 1005 to gateway server 1006. Utilizing the speech recognition system of the present invention in gateway server 1006, the query word is compared with a database of query word pronunciations and candidate query words are selected. These candidate query words are then transmitted back to mobile device 1001 via confirmation packet 1009 and displayed on display 201 which is part of mobile device 1001. The user at mobile device 1001 scrolls the candidate query words, highlights them, and selects the correct word. This selection transmits the desired query word back in WSP to gateway server 1006 utilizes a microbrowser to find the desired site 1008. Now the user at mobile device 1001 voice inputs a speech designated for the site 1008 via packet 1010. Speech packet 1011, after relay by antenna array 1004 is transmitted through gateway server 1006 to site 1008. Utilizing the speech recognition of the present invention, site 1008 compares the speech with a speech database installed at site 1008 and candidate speech is selected. In this embodiment of the invention, these candidates are transmitted back for via confirmation packet 1012. The candidates 204 are displayed on display 201 and, in the example above, the speech “IBM” 205 is scrolled, highlighted, and selected utilizing scroll button 202 and select button 203, which transmits it back to site 1008 in WSP, whereupon the concomitant content is transmitted via content packet 1015 through gateway server 1006 via packet 1016 to the antenna array 1004 and finally back to mobile device 1001 via packet 1017 which information content is displayed on display 201.

As Web content increases, information such as weather, stock quotes, banking services, financial services, e-commerce/business, navigation aids, retail store information (location, sales, etc.), restaurant information, transportation (bus, train, plane schedules, etc.), foreign exchange rates, entertainment information (movies, shows, concerts, etc.), and myriad other information will be available. The Internet Service Providers and the Internet Content Providers will provide the communication links and the content respectively.

While the above is a full description of the specific embodiments, various modifications, alternative constructions and equivalents may be used. For example, although some speech recognition techniques are described in detail, any speech recognition system can be used to generate the sequence of word and word string matches for scrolling and selection. The present invention is suitable for any verbal language that can be aggregated into word strings. Therefore, the above description and illustrations should not be taken as limiting the scope of the present invention which is defined by the following claims.

What is claimed is:

1. A speech recognition system comprising:
microphone means for receiving input speech and converting the input speech into digital electronic signals;
front-end signal processing means, coupled to said microphone means, for processing the digital electronic signals to generate parametric representations of the digital electronic signals;
word database storage means for storing parametric representations of a plurality of predetermined word pronunciations;
word similarity comparator means, communicable with said front-end signal processing means and coupled to said word database storage means, for comparing the parametric representation of the digital electronic signals with said parametric representations of said plurality of predetermined word pronunciations, and generating a sequence of words selected from said plurality of predetermined word pronunciations in said word database storage means responsive to predetermined criteria for matching said input speech; and
display means, communicable with said word similarity comparator means, for displaying said sequence of words, comprising a scrolling means for scrolling through said sequence of words; a highlighting means, coupled to said scrolling means, for highlighting at least one of said sequence of words; and a selecting means, coupled to said scrolling means and said highlighting means, for selecting one of said sequence of words.

2. The speech recognition system of claim 1 wherein said front-end signal processing means generates digitally parameterized speech features for transmission to said word similarity comparator means.

3. The speech recognition system of claim 1 wherein said front-end signal processing means generates predetermined digitally parameterized acoustic parameters to said word similarity comparator means.

4. The speech recognition system of claim 1 wherein said front-end signal processing means comprises:
preemphasizer means for spectrally flattening the digital electronic signals generated by said microphone means;
frame-blocking means, coupled to said preemphasizer means, for blocking the digital electronic signals into frames of N samples with adjacent frames separated by M samples;
windowing means, coupled to said frame-blocking means, for windowing each frame;
autocorrelation means, coupled to said windowing means, for autocorrelating the frames;
cepstral coefficient generating means, coupled to said autocorrelation means, for converting each frame into cepstral coefficients; and
tapered windowing means, coupled to said cepstral coefficient generating means, for weighting the cepstral coefficients.

5. The speech recognition system of claim 1 wherein said word similarity comparator means comprises:
word calibration means, coupled to said word database storage means, for calibrating the parametric representations of the digital electronic signals with said parametric representations of said plurality of word pronunciation stored in said word database storage means;
dynamic time warper means for performing dynamic time warping on the parametric representations of the digital electronic signals and said parametric representations of said plurality of word pronunciations stored in said word database storage means;
distortion calculation means, coupled to said word calibration means and to said dynamic time warper means, for calculating a distortion between the parametric representations of the digital electronic signals and said parametric representations of said plurality of word pronunciations stored in said word database storage means;
scoring means, coupled to said distortion calculation means, for assigning a score to said distortion responsive to predetermined criteria; and
selection means, coupled to said scoring means, for selecting at least one of said parametric representations of said plurality of word pronunciations stored in said word database storage means having the lowest distortions.

6. The speech recognition system of claim 5 wherein said dynamic time warper means comprises minimization means for determining the minimum cepstral distances between the parametric representation of the digital electronic signals and said plurality of parametric representations of the word pronunciations stored in said word database storage means.

7. The speech recognition system of claim 6 wherein the words in said word database storage means corresponding to said selected at least one of said parametric representations of said plurality of word pronunciations stored in said word database storage means having the lowest distortions are displayed on said display in order of low to high distortions.

8. The speech recognition system of claim 1 wherein said microphone means, said front-end signal processing means, and said display are disposed in a mobile communication device.

9. The speech recognition system of claim 1 wherein said word database storage means, said word similarity comparator means are disposed in a server at a telecommunications site.

10. The speech recognition system of claim 8 wherein said mobile communication device communicates with the Internet.

11. The speech recognition system of claim 1 wherein said plurality of predetermined word pronunciation parametric representations include site category words on a communications network.

12. The speech recognition system of claim 1 wherein said plurality of predetermined word pronunciation parametric representations include company names on a stock exchange.

13. The speech recognition system of claim 1 wherein said plurality of predetermined word pronunciation parametric representations include transportation information related words.

14. The speech recognition system of claim 1 wherein said plurality of predetermined word pronunciation parametric representations include entertainment information related words.

15. The speech recognition system of claim 1 wherein said plurality of predetermined word pronunciation parametric representations includes restaurant information words.

16. The speech recognition system of claim 1 wherein said plurality of predetermined word pronunciation parametric representations include foreign exchange rate information related words.

17. The speech recognition system of claim 1 wherein said plurality of predetermined word pronunciation parametric representations include retail store name words.

18. The speech recognition system of claim 1 wherein said plurality of predetermined word pronunciation parametric representations include banking services related words.

19. The speech recognition system of claim 1 wherein said plurality of predetermined word pronunciation parametric representations include financial services related words.

20. The speech recognition system of claim 1 wherein said plurality of predetermined word pronunciation parametric representations include e-commerce and e-business related words.

21. A speech recognition system comprising:
microphone means for receiving a speech input and converting the speech input into digital electronic signals;
front-end signal processing means, coupled to said microphone means, for processing the digital electronic signals to generate parametric representations of the digital electronic signals;
word database storage means for storing a plurality of parametric representations of word pronunciations;
word similarity comparator means, communicable with said front-end signal processing means and to said word database storage means, for comparing the parametric representation of the digital electronic signals with said plurality of parametric representations of word pronunciations, and generating a first sequence of associations between the parametric representation of the digital electronic signals and said plurality of parametric representations of word pronunciations in said word database storage means responsive to predetermined criteria;
word string database storage means for storing a plurality of parametric representations of word string pronunciations;
word string similarity comparator means, coupled to said word similarity comparator and to said word string database storage means, for comparing a plurality of aggregated parametric representations of word pronunciations with said plurality of parametric representations of word string pronunciations in said vocabulary database storage means, and generating a second sequence of associations between at least one of said plurality of aggregated parametric representations of the word pronunciations with at least one of said plurality of parametric representations of word string pronunciations stored in said word string database storage means responsive to predetermined criteria; and
display means, coupled to said word string similarity comparator means, for displaying said second sequence of associations, comprising a scrolling means for scrolling through said second sequence of associations; a highlighting means, coupled to said scrolling means, for highlighting at least one of said second sequence of associations; and a selecting means, coupled to said scrolling means and said highlighting means, for selecting one of said second sequence of associations.

22. The speech recognition system of claim 21 wherein said word pronunciations and word string pronunciations are in the Korean language.

23. The speech recognition system of claim 21 wherein said word pronunciations and word string pronunciations are in the Japanese language.

24. The speech recognition system of claim 21 wherein said word pronunciations and word string pronunciations are in the Chinese language.

25. The speech recognition system of claim 21 wherein said microphone, said front-end signal processing means, and said display are disposed in a mobile communication device.

26. The speech recognition system of claim 25 wherein said mobile communications device communicates with the Internet.

27. The speech recognition system of claim 21 wherein said word database storage means, said word similarity comparator means, said word string database storage means, and said word string similarity comparator means are disposed in a server at a network communications site.

28. The speech recognition system of claim 21 wherein said plurality of word pronunciations and word string pronunciations include site category words on a communications network.

29. The speech recognition system of claim 21 wherein said plurality of word pronunciations and word string pronunciations include company names on a stock exchange.

30. The speech recognition system of claim 21 wherein said plurality of word pronunciations and word string pronunciations include transportation information related words.

31. The speech recognition system of claim 21 wherein said plurality of word pronunciations and word string pronunciations include entertainment information related words.

32. The speech recognition system of claim 21 wherein said plurality of word pronunciations and word string pronunciations include restaurant information words.

33. The speech recognition system of claim 21 wherein said plurality of word pronunciations and word string pronunciations include weather information words.

34. The speech recognition system of claim 21 wherein said plurality of word pronunciations and word string pronunciations include retail store name words.

35. The speech recognition system of claim 21 wherein said plurality of word pronunciations and word string pronunciations include banking services related words.

36. The speech recognition system of claim 21 wherein said plurality of word pronunciations and word string pronunciations include financial services related words.

37. The speech recognition system of claim 21 wherein said plurality of word pronunciations and word string pronunciations include e-commerce and e-business related words.

38. The speech recognition system of claim 21 wherein said plurality of word pronunciations and word string pronunciations include navigation aids words.

39. A speech similarity comparator comprising:
means for receiving digital electronic signals parametric representations;
word database storage means for storing a plurality of word pronunciation parametric representations;
word calibration means, coupled to said receiving means and to said word database storage means, for calibrating the digital electronic signals parametric representations with said plurality of word pronunciation parametric representations stored in said word database storage means;
dynamic time warper means for performing dynamic time warping on the digital electronic signals parametric representations and said plurality of word pronunciation parametric representations stored in said word database storage means;
distortion calculation means, coupled to said word calibration means and to said dynamic time warper means, for calculating a distortion between the digital electronic signals parametric representations and said plurality of word pronunciation parametric representations stored in said word database storage means;
scoring means, coupled to said distortion calculation means, for assigning a score to said distortion responsive to predetermined criteria;
word selection means, coupled to said scoring means, for selecting at least one of said plurality of word pronunciation parametric representations having the lowest distortion scores; and
display means, coupled to said selection means, for displaying said selected at least one of said plurality of words, said display means including a scrolling means for scrolling through said sequence of words; a highlighting means, coupled to said scrolling means, for highlighting at least one of said selected words; and a final selecting means, coupled to said scrolling means and said highlighting means, for a final selecting of one of said selected words.

40. The speech similarity comparator of claim 39 further comprising:
word string database storage means for storing a plurality of word string pronunciation parametric representations;
word string distortion calculation means, coupled to said word selection means, for calculating a distortion between an aggregation of said selected words parametric representations and said plurality of word string pronunciation parametric representations stored in said word string database storage means;
word string scoring means, coupled to said word string distortion calculation means, for assigning a score to said word string distortion responsive to predetermined criteria; and
word string selection means, coupled to said word string scoring means, for selecting at least one of said plurality of word string pronunciation parametric representations having the lowest word string distortion scores.

41. The speech similarity comparator of claim 40 wherein said display means, being communicable with said word string selection means, further displays said selected at least one of said plurality of word strings, scrolls through said selected word strings, highlights at least one of said selected word strings; and a finally selects one of said selected word strings.

42. In a network communications system having a plurality of mobile communication devices communicable with at least one server, and a plurality of sites communicable with the server, a speech recognition system comprising:
a signal processor, disposed in the mobile communication device, for digitally parameterizing a category word voice input signal;
a category word database, disposed in the server, for storing a plurality of predetermined parameterized category word pronunciations;
a category word comparator, communicable with said signal processor and coupled to said category word database, for comparing said digitally parameterized category word voice input signal with said plurality of parameterized category word pronunciations in said category word database;
a category word selector, coupled to said category word comparator, for selecting at least one category word of said plurality of parameterized category word pronunciations responsive to predetermined criteria utilized by said category word comparator; and
a display, coupled to said first selector, including a scrolling means for scrolling through said selected at least one category word; a highlighting means, coupled to said scrolling means, for highlighting at least one of said selected at least one category word; and a selecting means, coupled to said scrolling means and said highlighting means, for a final selecting of one of said selected at least one category word.

43. The speech recognition system of claim 42 further comprising a site map table, stored in said category word database, for mapping said selected category word to a category database stored in said category word database.

44. The speech recognition system of claim 42 wherein the server, responsive to said selection by said first selector selects at least one category word of said plurality of category word pronunciations, transmits said at least one category word back to said display for said final selection.

45. The speech recognition system of claim 42 further comprising
a speech words database, disposed at at least one of the plurality of sites, for storing a plurality of predetermined parameterized speech words pronunciations;
a speech words comparator, communicable with said signal processor and coupled to said speech words database, for comparing said digitally parameterized speech words voice input signal with said plurality of parameterized speech words pronunciations in said speech words database; and
a speech words selector, coupled to said speech words comparator, for selecting at least one speech word of said plurality of parameterized speech words pronunciations responsive to predetermined criteria utilized by said speech words comparator.

46. The speech recognition system of claim 45 wherein said speech words database includes a speech table for mapping said selected speech words to a predetermined content database.

47. The speech recognition system of claim 46 wherein said display further comprises content display means for displaying content from said predetermined content database.

48. The speech recognition system of claim 47wherein at least one of said sites of said plurality of sites transmits content from said mapped predetermined content database to said display.

49. The speech recognition system of claim 45 wherein said speech words selector, responsive to said selection, transmits said at least one speech word back to said display for said final selection.

50. The speech recognition system of claim 42 wherein the network communication system is the Internet.

51. The speech recognition system of claim 42 where the plurality of sites are a plurality of websites.

52. In a network communications system having a plurality of mobile communication devices communicable with at least one server, and a plurality of sites communicable with the server, a speech recognition system comprising:
a signal processor, disposed in the mobile communication device, for digitally parameterizing a voice input signal;
a word database, disposed in the server, communicable with said signal processor, for storing a plurality of predetermined parameterized word pronunciations;
a word comparator, communicable with said signal processor and coupled to said word database, for comparing said digitally parameterized voice input signal with said plurality of parameterized word pronunciations in said word database;
a word selector, coupled to said word comparator, for selecting at least one of said plurality of parameterized word pronunciations in said word database responsive to predetermined criteria utilized by said word comparator;
a category word string database for storing a plurality of parameterized category word string pronunciations;
a category word string comparator, coupled to said signal processor and to said category word string database, for comparing an aggregation of said selected word pronunciations with said parameterized category word string pronunciations in said category word string database; and
a category word string selector, coupled to said category word string comparator, for selecting at least one word string from said plurality of parameterized category word string pronunciations in said category word string database responsive to predetermined criteria utilized by said category word string comparator.

53. The word recognition system of claim 52 further comprising a display, communicable with said category word string selector, for displaying said selected at least one word string from said plurality of category word string pronunciations, including a scroller for scrolling through said selection of word strings; a highlighter, coupled to said scrolling means, for highlighting at least one of said selection of word strings; and a final selector, coupled to said scroller and said highlighter, for selecting one of said highlighted word strings.

54. In a network communications system having a plurality of mobile communication devices communicable with at least one server, and a plurality of sites communicable with the server, a speech recognition system comprising:
a signal processor, disposed in the mobile communication device, for digitally parameterizing a voice input signal;
a speech word database, disposed in the server, communicable with said signal processor, for storing a plurality of parameterized speech pronunciations;
a speech word comparator, communicable with said signal processor and coupled to said speech word database, for comparing said digitally parameterized voice input signal with said plurality of parameterized speech word pronunciations in said speech word database;
a speech word selector, coupled to said speech word comparator, for selecting at least one of said plurality of parameterized word pronunciations in said speech word database responsive to predetermined criteria utilized by said speech word comparator;
a speech word string database for storing a plurality of parameterized speech word string pronunciations;
a speech word string comparator, coupled to said signal processor and to said database storage unit, for comparing said selected speech word pronunciations with said parameterized speech word string pronunciations in said parameterized speech word string database; and
a speech word string selector, coupled to said speech word string comparator, for selecting at least one of the word strings of said plurality of parameterized speech word string pronunciations in said speech word string database responsive to predetermined criteria utilized by said speech word string comparator.

55. The word recognition system of claim 54 further comprising a display, communicable with said speech word string selector, for displaying said selected at least one of the word strings of said plurality of speech word string pronunciations, including a scroller for scrolling through said selection of word strings; a highlighter, coupled to said scrolling means, for highlighting at least one of said selection of word strings; and a final selector, coupled to said scroller and said highlighter, for selecting one of said highlighted word strings.

56. In a network communications system having a plurality of mobile communication devices communicable with at least one server, and a plurality of sites communicable with the server, a speech recognition system comprising:
a signal processor, disposed in the mobile communication device, for digitally parameterizing a voice input signal;
a word database, disposed in the server, communicable with said signal processor, for storing a plurality of parameterized word pronunciations;
a word comparator, communicable with said signal processor and coupled to said word database, for comparing said digitally parameterized voice input signal with said plurality of parameterized word pronunciations in said word database;
a word selector, coupled to said word comparator, for selecting at least one of said plurality of parameterized word pronunciations in said word database responsive to predetermined criteria utilized by said word comparator;
a category word string database for storing a plurality of parameterized category word string pronunciations;
a category word string comparator, communicable with said signal processor and coupled to said category word string database, for comparing and aggregation of said selected words pronunciations with said category word string pronunciations in said category word string database;
a category word string selector, coupled to said category word string comparator, for selecting at least one of the word strings of said plurality of category word string pronunciations in said category word string database responsive to predetermined criteria utilized by said category word string comparator, thereby selecting at least one word string category;
a speech word database, disposed in the server, communicable with said signal processor, for storing a plurality of parameterized speech pronunciations;
a speech word comparator, communicable with said signal processor and coupled to said speech word database, for comparing said digitally parameterized voice input signal with said plurality of parameterized speech word pronunciations in said speech word database;
a speech word selector, coupled to said speech word comparator, for selecting at least one of said plurality of word pronunciations in said speech word database responsive to predetermined criteria utilized by said speech word comparator;
a speech word string database for storing a plurality of parameterized speech word string pronunciations;
a speech word string comparator, coupled to said signal processor and to said database storage unit, for comparing said selected speech word pronunciations with said speech word string pronunciations in said speech word string database;
a speech word string selector, coupled to said speech word string comparator, for selecting at least one word string from said plurality of parameterized speech word string pronunciations in said speech word string database responsive to predetermined criteria utilized by said speech word string comparator;
a plurality of content databases, respectively disposed at the plurality of sites, comprising information contents; and
a speech word string-to-content mapper for mapping said selected word string to at least one of said plurality of content databases.

57. The word recognition system of claim 56 further comprising a display, communicable with said category word string selector, for displaying said selected at least one category word string from said plurality of parameterized category word string pronunciations, including a scroller for scrolling through said selection of word strings; a highlighter, coupled to said scrolling means, for highlighting at least one of said selection of category word strings; and a final selector, coupled to said scroller and said highlighter, for selecting one of said highlighted category word strings.

58. The word recognition system of claim 56 further comprising a display, communicable with said speech word string selector, for displaying said selected at least one word string from said plurality of speech word string pronunciations, including a scroller for scrolling through said selection of word strings; a highlighter, coupled to said scrolling means, for highlighting at least one of said selection of word strings; and a final selector, coupled to said scroller and said highlighter, for selecting one of said highlighted word strings.

59. The speech recognition system of claim 56 wherein the plurality of sites transmits said information contents to the mobile communication device responsive to said mapping.

60. A method for recognizing speech input, comprising the steps of:
(a) parameterizing a predetermined plurality of word pronunciations;
(b) storing said predetermined plurality of parameterized word pronunciations;
(c) receiving the speech input;
(d) converting the speech input into digital electronic signals;
(e) parameterizing the digital electronic signals;
(f) comparing said parameterized digital electronic signals with said stored predetermined plurality of parameterized word pronunciations;
(g) selecting at least one of said stored predetermined plurality of parameterized word pronunciations responsive to predetermined parameter similarity criteria;
(h) displaying said selected at least one of said stored plurality of parameterized word pronunciations;
(i) scrolling through said selected at least one of said stored plurality of parameterized word pronunciations;
(j) highlighting at least one of said selected at least one of said stored plurality of parameterized word pronunciations; and
(k) further selecting one of said highlighted selected at least one of said stored plurality of parameterized word pronunciations.

61. The method of claim 60 wherein step (a) comprises utilizing cepstral coefficients to parameterize said plurality of parameterized word pronunciations.

62. The method of claim 60 wherein step (e) comprises utilizing linear predictive coding to parameterize the digital electronic signals.

63. The method of claim 60 wherein step (f) comprises utilizing cepstral distances to compare the parameterized digital electronic signals with said plurality of parameterized word pronunciations.

64. A method for recognizing speech input, comprising the steps of
(a) parameterizing a predetermined plurality of word pronunciations;
(b) storing said predetermined plurality of parameterized word pronunciations;
(c) parameterizing a predetermined plurality of word string pronunciations;
(d) storing said predetermined plurality of parameterized of word string pronunciations;
(e) receiving the speech input;
(f) converting the speech input into digital electronic signals;
(g) parameterizing the digital electronic signals;
(h) comparing said parameterized digital electronic signals with said stored predetermined plurality of parameterized word pronunciations;
(i) selecting at least one of said stored predetermined plurality of parameterized word pronunciations responsive to predetermined parameter similarity criteria;
(j) aggregating said selected at least one of said stored plurality of parameterized word pronunciations to form a parameterized word string representing a word string;
(k) comparing said parameterized word string with said stored predetermined plurality of parameterized word string pronunciations;
(l) selecting at least one of said stored predetermined plurality of parameterized word string pronunciations responsive to predetermined parameter similarity criteria;
(m) displaying said selected at least one of said word strings represented by said word string pronunciations in said stored plurality of parameterized word string pronunciations in a similarity sequence responsive to said predetermined parameter similarity criteria;
(n) scrolling through said selected at least one of said stored predetermined plurality of parameterized word string pronunciations;
(o) highlighting at least one of said word strings in said selected at least one of said stored predetermined plurality of parameterized word string pronunciations; and
(p) further selecting one of said highlighted selected at least one of said stored predetermined plurality of parameterized word string pronunciations.

65. The method of claim 64 wherein step (c) comprises utilizing cepstral coefficients to parameterize said predetermined plurality of parameterized word string pronunciations.

66. The method of claim 64 wherein step (k) comprises utilizing cepstral distances to d compare said parameterized word string with said predetermined plurality of parameterized word string pronunciations.

67. A method of voice communication with a network communication system having a plurality of sites comprising the steps of:
(a) comparing a voice input comprising at least one category word with a database of predetermined category word pronunciations;
(b) selecting at least one category word from said database of predetermined category word pronunciations responsive to predetermined word similarity criteria; and
(c) establishing a communication link between the situs of said voice input and the site corresponding to said selected at least one category word responsive to said selected at least one category word.

68. The method of claim 67 further comprising the steps after step (b) of
displaying said selected at least one category word;
scrolling through said selected at least one category word;
highlighting at least one of said selected at least one said category word; and
further selecting one of said highlighted selected at least one category word.

69. The method of claim 67 further comprising the steps of:
(d) comparing a voice input comprising at least one speech word with a database of predetermined speech word pronunciations;
(e) selecting at least one speech word from said database of predetermined speech word pronunciations; and
(f) transmitting said selected at least one speech word to said site corresponding to said selected at least one category word.

70. The method of claim 69 further comprising the steps after step (e) of:
displaying said selected at least one speech word;
scrolling through said selected at least one speech word;
highlighting at least one of said selected at least one speech word; and
further selecting one of said highlighted selected at least one speech word.

71. The method of claim 69 further comprising the step of:
(g) transmitting content from said site corresponding to said selected at least one category word responsive to said selected at least one speech word.

72. The method of claim 69 further comprising the steps after step (e) of:
aggregating said selected speech words to form word strings;
comparing said speech word strings with a database of predetermined word string pronunciations;
selecting at least one speech word string from said database of predetermined speech word string pronunciations; and
transmitting said selected one speech word string pronunciation to said site corresponding to said selected at least one category word.

73. The method of claim 72 further comprising the steps, after the step of selecting at least one speech word string, of:
displaying said selected at least one speech word string;
scrolling through said selected at least one speech word string;
highlighting at least one of said selected at least one speech word string; and
further selecting one of said highlighted selected at least one speech word string.

74. The method of claim 72 further comprising the step of:
transmitting content from said site corresponding to said selected at least one category word responsive to said selected at least one speech word string.
